(19) United States
(12) Patent Application Publication
(10) Pub. No.: US 2010/0312955 A1
(43) Pub. Date: Dec. 9, 2010

(54) MEMORY SYSTEM AND METHOD OF MANAGING THE SAME

(75) Inventors: Joo-young HWANG, Suwon-si (KR); Min-chan Kim, Suwon-si (KR)

Correspondence Address: North Star Intellectual Property Law, PC, P.O. Box 34688, Washington, DC, 20043, US

(73) Assignee: SAMSUNG ELECTRONICS CO., LTD., Suwon-si (KR)

(21) Appl. No.: 12/756,622

(22) Filed: Apr. 8, 2010

(30) Foreign Application Priority Data
Jun. 9, 2009 (KR) 10-2009-0050968

(51) Int. Cl. G06F 12/00; G06F 12/10

(52) U.S. Cl. 711/105; 711/206; 711/E12.001; 711/E12.058

(57) ABSTRACT

A memory system to manage a memory using a virtual memory is provided. The memory system may use an asymmetric memory as a swap storage of a dynamic random access memory (DRAM). The asymmetric memory may access on a byte basis, allowing a process to directly access a page swapped out to the asymmetric memory through direct mapping.

### CROSS REFERENCE TO RELATED APPLICATION(S)

This application claims the benefit under 35 U.S.C. §119(a) of Korean Patent Application No. 10-2009-0050968, filed on Jun. 9, 2009, the entire disclosure of which is incorporated herein by reference for all purposes.

### BACKGROUND

1. Field

The following description relates to a memory system, and more particularly, to a memory system of managing a memory using a virtual memory.

2. Description of the Related Art

A conventional operating system utilizes swap storage to provide a substantially large capacity of memory using a virtual memory so that it may overcome capacity limitations of a physical memory. A storage space as large as the amount of the memory required to execute each process is secured in the swap storage, and only a portion of memory contents which is required to be executed immediately is loaded into the memory. If the memory contents are not to be executed immediately, they are copied into an area in the swap storage. More specifically, a swap-out operation is performed. Furthermore, at a time of execution of the memory contents, the memory contents are loaded into the memory. In other words, a swap-in operation is performed, and the process continues.

### SUMMARY

In one general aspect, there is provided a memory system including an asymmetric memory, a dynamic random access memory (DRAM), and a control unit to use the asymmetric memory as swap storage of the DRAM and to move a page selected to be swapped out by the DRAM to the asymmetric memory.

The control unit may map an address of a page which is directly swapped out to the asymmetric memory to a page table of the swapped-out page such that a process may directly access the swapped-out page.

The control unit may assign a lower priority to pages on which write operations are frequently performed in response to selecting the pages to be swapped out.

The control unit may manage pages with an active list and an inactive list, the active list includes pages which have been recently referred to and the inactive list includes pages which have not been recently referred to and may be divided into an inactive write list and an inactive read list according to an occurrence of write operations.

The control unit may scan the inactive write list and the inactive read list and may promote pages which have been recently referred to twice or more to the active list.

The control unit may reduce the active list by moving pages which have not been recently referred to from the active list to either the inactive write list or the inactive read list according to an occurrence of write operations in each page, may reduce the inactive write list by moving pages to which a write operation has not been recently performed to the inactive read list and may select pages to be swapped out from the inactive read list after reducing the inactive write list.

In response to reducing the inactive write list, the control unit may scan a page and may locate the scanned page in a tail of the inactive read list when it is determined that a dirty bit and a reference bit have not been set corresponding to the scanned page with reference to a page table entry of the scanned page.

The control unit may manage the swapped-out pages with a least recently written (LRW) list arranged in the order of recently written pages and may select most recently written pages to be swapped in.

The control unit may assign a read-only permission corresponding to the swapped-out pages, changes a read-only permission corresponding to the swapped-out page to a read/write permission in order to permit a write operation on the page in response to a write request corresponding to the swapped-out page being received, and may move the page to which the write operation has been performed to a head of the LRW list.

The control unit, in response to scanning the LRW list, may mark pages to be migrated, the pages having a read/write permission assigned, changes a status of the marked pages to read-only, may generate a page fault in the marked page where write access to the marked page occurs, and may move the page where the page fault has occurred to the DRAM.

The control unit may move the swapped-out pages to the DRAM in response to a size of a free page in the DRAM exceeding a threshold value.

In another general aspect, there is provided a method of managing a memory system including an asymmetric memory and a dynamic random access memory (DRAM), the method including moving pages selected to be swapped out by the DRAM to the asymmetric memory by using the asymmetric memory as a swap storage of the DRAM.

The method may further include mapping an address of a page which is directly swapped out to the asymmetric memory to a page table of the swapped-out page such that a process can directly access the swapped-out page.

The method may further include assigning a lower priority to frequently written pages in response to the pages being selected to be swapped out.

The method may further include in order to select the pages to be swapped out, managing pages with an active list and an inactive list, the active list including pages which have been recently referred to and the inactive list including pages which have not been recently referred to, wherein the inactive list is divided into an inactive write list and an inactive read list according to an occurrence of write operations.

The method may further include scanning the inactive write list and the inactive read list and promoting pages which have been recently referred to twice or more to the active list.

The managing of the pages may include reducing the active list by moving pages which have not been recently referred to from the active list to either the inactive write list or the inactive read list according to an occurrence of write operations to each page, reducing the inactive write list by moving pages to which a write operation has not been recently performed to the inactive read list, and selecting pages to be swapped out from the inactive read list.

The method may further include managing the swapped-out pages with a least recently written (LRW) list arranged in the order of recently written pages, and selecting most recently written pages been performed to be swapped in.

The managing of the swapped-out pages may include assigning read-only permission corresponding to the swapped-out pages, changing the read-only permission corresponding to the swapped-out page to a read/write permission in order to permit a write operation to be performed on the page in response to a write request corresponding to the swapped-out page being received, and moving the page to which the write operation has been performed to a head of the LRW list.

The method may further include in response to scanning the LRW list, marking the pages to be migrated, the pages for which a read/write permission is assigned, and changing the status of the pages to read-only, generating a page fault in the marked page in response to a write access occurring to the marked page, and moving the page where the page fault has occurred to the DRAM.

Other features and aspects will be apparent from the following detailed description, the drawings, and the claims.

### BRIEF DESCRIPTION OF THE DRAWINGS

FIG. 1 is a block diagram illustrating an example of a memory system.

FIG. 2 is a flowchart illustrating an example of an operation of direct mapping according to swap-out.

FIG. 3 is a diagram illustrating an example of page management in accordance with a least recently used (LRU) algorithm.

FIG. 4 is a flowchart illustrating examples of procedures of retrieving a page to obtain a free page.

FIG. 5 is a diagram illustrating an example of an operation of active list reduction.

FIG. 6 is a diagram illustrating an example of an operation of inactive write list reduction.

FIG. 7 is a diagram illustrating an example of an operation of inactive read list management.

FIG. 8 is a diagram illustrating an example of an operation of a migration daemon.

FIG. 9 is a diagram illustrating an example of an operation of least recently written (LRW) management of a swap page.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Descriptions of well-known functions and constructions may be omitted for increased clarity and conciseness.

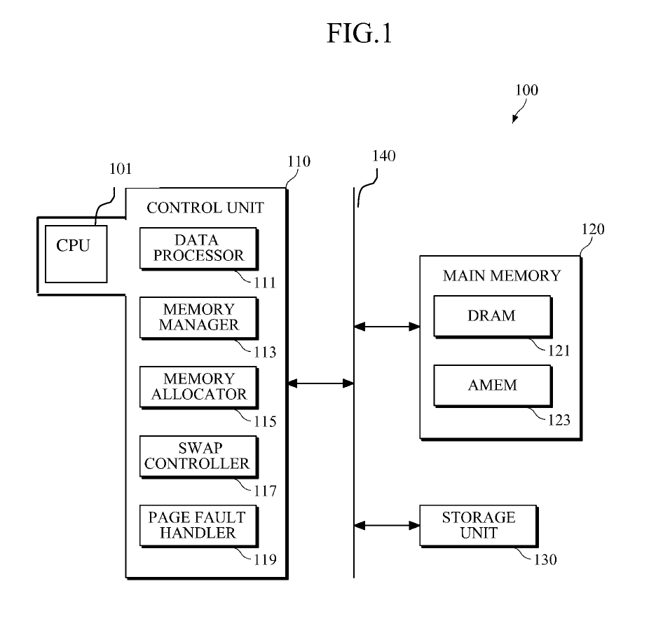

FIG. 1 illustrates an example of a memory system 100. Referring to FIG. 1, the memory system 100 includes a control unit 110, a main memory 120, and a storage unit 130. A vertical solid line represents a bus 140 through which data and commands are transferred between the control unit 110, the main memory 120, and the storage unit 130.

The control unit 110 may include a separate central processing unit (CPU) 101 (or a microcontroller) to process data and read and/or write data from and/or to the main memory 120 and the storage unit 130.

Referring to FIG. 1, the main memory 120 exchanges data directly with the control unit 110, and is used to execute functions of an operating system or an application run in the control unit 110. The main memory 120 includes a dynamic random access memory (DRAM) 121 and an asymmetric memory (AMEM) 123.

The control unit 110 can read and/or write data from and/or to the AMEM 123 on a byte basis, but the AMEM 123 has a significant difference between its read and write performances. A typical example of the AMEM 123 is a phase change memory. The phase change memory has a similar read performance as the DRAM 121, but this read performance is at least ten times slower than its write performance.

Data stored in the storage unit 130 is not erased even when power supply is removed, and since the storage unit 130 has a greater capacity than that of the main memory 120, it is used to store data. The data stored in the storage unit 130 is loaded into the main memory 120, and is processed by the control unit 110.

The control unit 110 includes a data processor 111, a memory manager 113, a memory allocator 115, a swap controller 117, and a page fault handler 119. The control unit 110 may further include other functional units (not illustrated), and specified functions of each of the memory manager 113, the memory allocator 115, the swap controller 117 and the page fault handler 119 may be executed by some of the additional functional units. In addition, the control unit 110 may include the additional functional units in the form of chip sets external to the control unit 110 or may implement some of the additional functional units as program codes in an operating system. For example, the control unit 110 uses the AMEM 123 as swap storage of the DRAM 121 and moves pages to be swapped out to the AMEM 123, so that the control unit 110 can retrieve pages from the DRAM 121, thereby increasing a number of free pages of the DRAM 121.

Referring to FIG. 1, the data processor 111 is configured as a central processing unit (CPU) or a microcontroller to execute processes of an operating system or an application.

The memory manager 113 converts a virtual address of a memory region to a physical address. More specifically, the memory manager 113 converts the virtual address to a physical address with reference to a page table recording where a physical memory page is mapped to a virtual memory page. In addition, the memory manager 113 manages and updates page information of the page table while page data reading or page data writing is performed according to the process.

The page table may include fields that indicate a status of a corresponding page in addition to the physical address which is mapped to the virtual address of each page. Each field which indicates a page status may include a reference bit indicating whether the process has reference to a recent page, a dirty bit indicating whether the process changes the contents of the page, and a read/write bit indicating whether read and/or write has been performed.

For example, the memory manager 113 may perform direct mapping to the page table of the swapped-out page such that a physical address of the AMEM 123 is mapped to the page table of the swapped-out page, and thus thereafter the process is allowed to directly access the page swapped out to the AMEM 123. Accordingly, in response to the data processor 111 reading the page swapped out to the AMEM 123 from the DRAM 121, the memory manager 113 transfers the physical address of the AMEM 123 to the data processor 111 so that the data processor 111 may read data of the page stored in the AMEM 123.

The memory allocator 115 allocates main memory corresponding to a computer program. The memory allocator 115 may manage a page list in order to manage a memory space of the DRAM 121 and a memory space of the AMEM 123 on a page basis. The memory allocator 115 may manage pages of the DRAM 121 such that pages to which write operations are frequently performed may have a lower priority in terms of a swap-out process. Furthermore, the memory allocator 115 manages the pages swapped out to the AMEM 123 as a least recently written (LRW) list arranged in the order of pages to which a writing operation has recently been performed (hereinafter referred to as “recently written pages”).

The swap controller 117 swaps out the pages of the DRAM 121 to the AMEM 123, and retrieves the pages of the DRAM 121. The swap controller 117 may be operated under the control of the memory allocator 115.

Where an operation which is not allowed occurs in a page, the page fault handler 119 generates a page fault. For example, where a write request operation occurs in a read-only page, the page fault is generated by the page fault handler 119. In addition, the page fault handler 119 swaps in the pages of the AMEM 123 to the DRAM 121 to control retrieval of the pages from the AMEM 123 where a page fault occurs in a swapped-out page.

Using the AMEM 123 as swap storage allows quicker swap-out and swap-in, compared to the use of a conventional hard disk or a NAND memory. Moreover, since the AMEM 123 may be read on a byte basis like the DRAM 121, data is read directly from the AMEM 123 without recovering the DRAM, which is generally performed in a swap-in process, and thus the read performance of the memory may be improved. In addition, since the AMEM 123 does not use power to refresh itself, unlike the DRAM 121, the power consumption may be reduced even more by using the AMEM 123 as a swap storage, as compared to where more DRAMs are used.

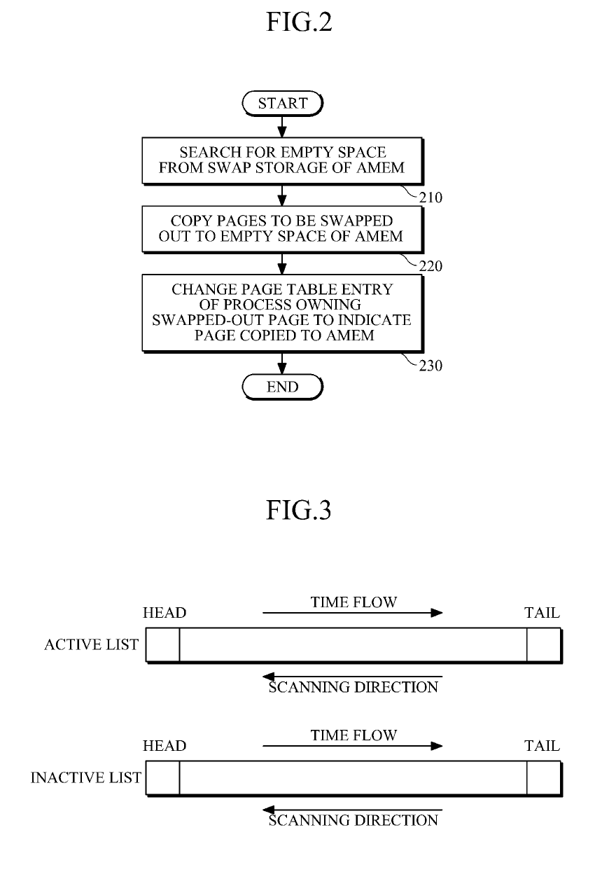

FIG. 2 illustrates an example of an operation of direct mapping according to swap-out, in conjunction with FIG. 1.

The memory allocator 115 transfers the control to the swap controller 117 in order to retrieve currently used pages due to a lack of free pages in the DRAM 121. At 210, the swap controller 117 searches to find an empty page in a swap space of the AMEM 123. At 220, the swap controller 117 copies a page to be swapped out to the empty page of the AMEM 123. Then, at 230, the memory manager 113 changes mapping, such that a physical address of a page table entry of a process owning a page to be swapped out indicates the copied page of the AMEM 123. Here, access allowance corresponding to the page copied to the AMEM 123 may be mapped as read-only. In addition, the memory allocator 115 may manage the swapped-out page by including the page in a head of an LRW list.

In using hard disk drive as swap storage, a page fault may occur where a process accesses a swapped-out page since the swapped-out page is an invalid page which does not exist in a memory. In order for the process to read data from the swapped-out page, an operating system copies the page where the page fault occurs from the hard disk drive to a free page in the DRAM 121, and maps the copied page of the DRAM to a page table of the corresponding process, and consequently the process is allowed to read data from the page copied to the DRAM using an address of the copied DRAM page.

However, where the AMEM memory 123 is used as swap storage, direct mapping is possible and thus various performance improvements may be achieved. First, no page fault occurs and overheads to copy the page from swap storage to a physical memory are not required where a process accesses a swapped-out page to read data. Therefore, an overhead to allocate a physical memory page which required corresponding to a page to be copied from swap storage to the physical memory may be prevented. In addition, a block input/output operation to read the page from the swap storage to the physical memory is not necessary.

Moreover, in a system utilizing an HDD as a swap device, since random access costs of the HDD are high, consecutive pages are read ahead so that other pages are read in addition to a page where a page fault occurs. In contrast, unlike the HDD, the AMEM 123 has a small random access cost, and thus complicated routines such as read-ahead of swapped pages may be prevented.

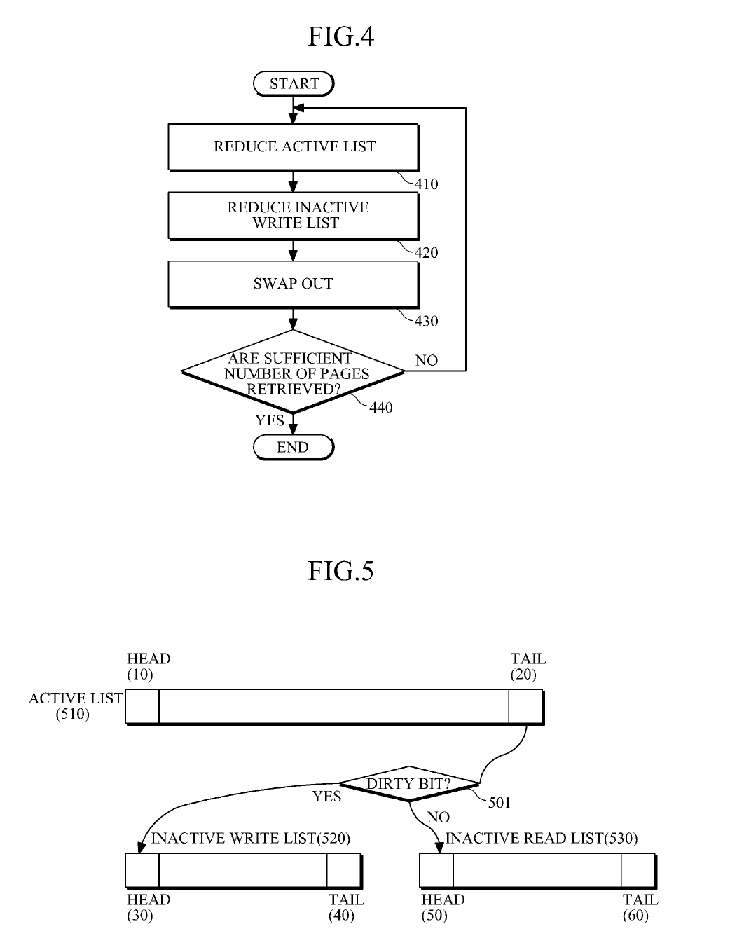

Since the write performed in the AMEM 123 is slow, where a page of a swap space of the AMEM 123 to which write operations are frequently performed is mapped to a process page, the general performance of the AMEM 123 deteriorates. In one example, the memory allocator 115 primarily swaps out pages, to which write operations are not frequently performed, to the swap space. Accordingly, a page management method in accordance with a least recently used (LRU) algorithm will be described with reference to FIG. 3, and a method of selecting a page to be swapped out will be described with reference to FIGS. 4 through 7.

FIG. 3 illustrates an example of page management in accordance with an LRU algorithm. Operating systems uses the LRU algorithm as a method of selecting a page to be swapped out in order to retrieve a page. The LRU algorithm selects the least recently used page, i.e. the oldest used page, to be swapped out. To apply the LRU algorithm, pages of DRAM 121 are managed by an active list and an inactive list.

The active list includes the most recently referred pages which are arranged from head to tail, and the inactive list includes the oldest unused pages which are arranged from tail to head.

A number of pages to be scanned is determined according to the amount of free memory existing in the DRAM 121, which is currently required by an operating system, i.e. a memory pressure, the active list is scanned to find pages which have not been frequently referred to, and the found pages are moved to the inactive list. Thereafter, the inactive list is scanned to find and select retrievable pages as pages to be swapped out, and then the found pages are retrieved. The operating system adds the retrieved pages to the free memory to meet memory requirements.

The operating system scans the active list from tail to head to find the recently referred pages and arranges the found pages in the head of the active list. Therefore, the pages in the active list are arranged based on time in a direction from head to tail. The page located in the tail of the active list is transferred to the inactive list when a new page is positioned at the head of the active list. The page transferred from the active list is placed first at the head of the inactive list. In addition, the operating system scans the inactive list from the tail to find a page which has been recently referred to, and, where a page is found, transfers the page to the active list by moving the page to the head of the active list. However, according to the LRU algorithm, a problem may occur in that a recently but not frequently used page swaps out a frequently but not recently used page.

In consideration of a drawback of the LRU algorithm, a second chance LRU algorithm is used to select a page to be swapped out such that only a page which has been referred to more than twice is transferred to the active list.

FIG. 4 illustrates examples of procedures of retrieving a page to obtain a free page, in conjunction with FIG. 1.

In one example, the inactive list is managed, divided into an inactive read list and an inactive write list. The memory allocator 115 may determine the number of pages to be scanned and the number of pages to be retrieved according to a current memory pressure.

The page retrieval is executed by sequentially performing active list reduction (410), inactive write list reduction (420) and swapping-out (430). Where the page retrieval fails to retrieve a desired number of pages (440) and the inactive read list has been completely scanned from head to tail, the operation returns to the active list reduction (410) and the page retrieval is re-attempted. Hereinafter, each operation will be described in detail with reference to FIGS. 5 through 7.

FIG. 5 illustrates an example of an operation of active list reduction.

The memory allocator 115 (see FIG. 1) determines the numbers of pages to be scanned and pages to be retrieved according to a current memory pressure. The memory allocator 115 scans an active list 510 within a predetermined range.

The memory allocator 115 searches to find pages to be retrieved from a tail 20 to a head 10 of the active list 510, and moves the found page to either an inactive read list 530 or an inactive write list 520 according to an occurrence of a write in the page to be retrieved. In detail, the memory allocator 115 examines a page table entry of the page to be retrieved to detect whether a dirty bit is set in the page (501), and where it is found that the dirty bit is set, the memory allocator 115 moves the page to be retrieved to a head 30 of the inactive write list 520, or otherwise (501), the memory allocator 115 moves the page to a head 50 of the inactive read list 530.

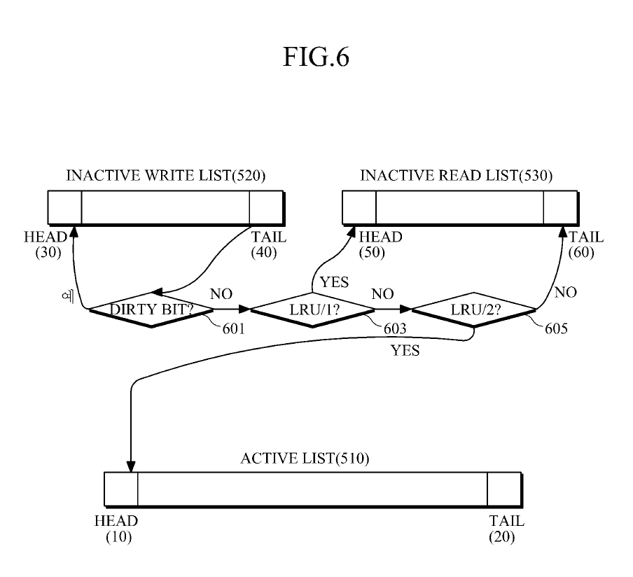

FIG. 6 illustrates an example of an operation of inactive write list reduction.

The memory allocator 115 (see FIG. 1) scans an inactive write list 520 to find pages with a high read performance, and moves the found pages to an inactive read list 530 to reduce the inactive write list 520.

The memory allocator 115 scans the inactive write list 520 in a direction from a tail 40 to a head 30. The memory allocator 115 examines a page table entry of the found page, and detects whether a dirty bit is set in the page (601). At 601, where it is determined that the dirty bit is set, the memory allocator 115 moves the found page to the head 30 of the inactive write list 520. In contrast, at 601, where it is determined that the dirty bit is not set, the memory allocator 115 moves the found page to a head 50 of the inactive read list 530 where the page is only referred to once (603). The memory allocator 115 moves the found page to a head 10 of the active list 510 where the page is referred to not only once (603), but twice (605).

Where it is determined that the dirty bit of the page is not set at 601 and it is determined that a reference bit is not set at 603 or 605, the reference bit indicates that the corresponding page has not been recently accessed, and thus the memory allocator 115 moves the page to a tail 60 of the inactive read list 530 such that the page may be retrieved quickly.

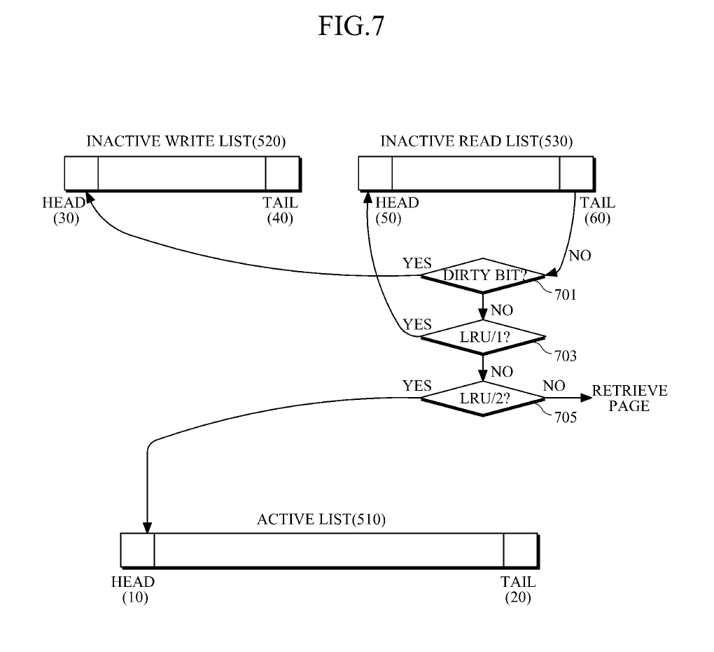

FIG. 7 illustrates an example of an operation of inactive read list management.

The memory allocator 115 (see FIG. 1) scans an inactive read list 530 from a tail 60 to a head 50. Where it is found that a dirty bit is set in a currently scanned page at 701, the memory allocator 115 moves the page to a head 30 of the inactive write list 520.

Where the dirty bit is not set at 701, at 703, the memory allocator 115 checks whether the page has been referred to once, and where the page has been referred to once, the memory allocator 115 moves the page to a head 50 of the inactive read list 530. Where it is determined at 705 that the page has been referred to twice, the memory allocator 115 moves the page to a head 10 of the active list 510.

Where both the dirty bit and a reference bit are not set in the page, the memory allocator 115 selects the page as a page to be swapped out. Pages to be swapped out may be marked, and where the memory allocator 115 issues a page retrieval request to the swap controller 117 (see FIG. 1), the swap controller 117 scans the inactive read list 530 to retrieve the pages to be swapped out. Where the pages are retrieved, the memory manager 113 sets a read-only permission on a page table entry of a swapped out page, and changes the page table entry such that a physical address of the swapped-out page is mapped to the AMEM 123 (see FIG. 1).

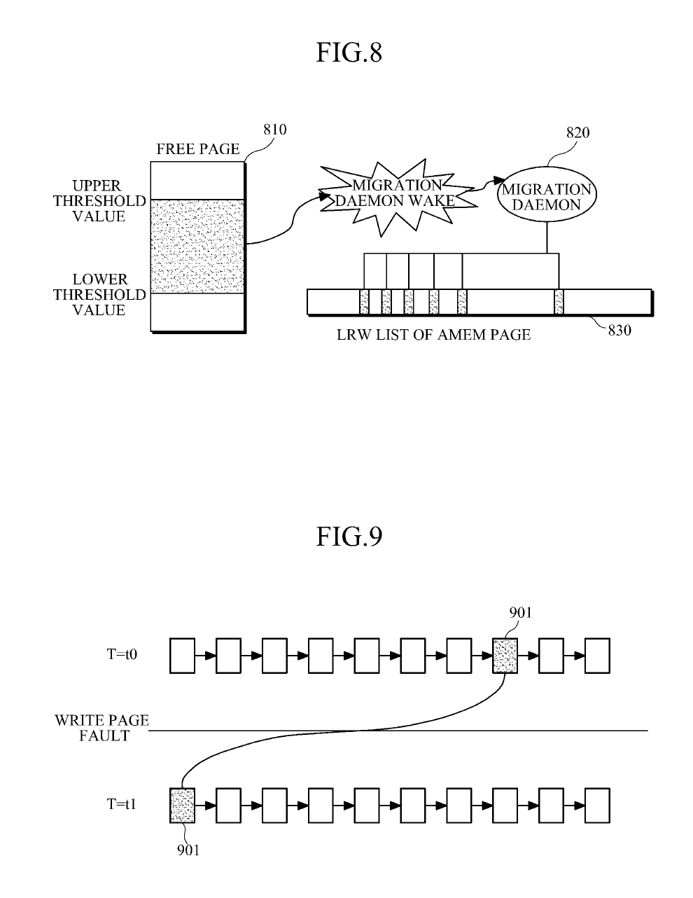

FIG. 8 illustrates an example of an operation of a migration daemon 820.

The memory allocator 115 (see FIG. 1) may request the swap controller 117 (see FIG. 1) to migrate a swapped out page to the DRAM 121 (see FIG. 1) where a free page 810 of the DRAM 121 is obtained having a page size greater than a predetermined threshold value. The predetermined threshold value may be between an upper threshold value and a lower threshold value.

Where the memory allocator 115 requests the swap controller 117 to perform a swap-in, the swap controller 117 provides a background daemon which is referred to as migration daemon 820 to select a page to be swapped in by scanning an LRW list 830 from its head to tail where the free page 820 of the DRAM 121 is obtained having a page size more than the predetermined threshold value. Since swapped-in pages, generally, are not frequently referred to, where all such pages are moved to the DRAM 121, the performance of the system may deteriorate. Thus, the threshold value corresponding to the free page is determined in order to prevent pages from being swapped in until the entire free page 810 of the system is exhausted.

In one example, the swap controller 117 primarily moves the recently written swap pages to the DRAM 121 from the head of the LRW list 830.

FIG. 9 illustrates an example of an operation of LRW management of a swap page.

In the current example, swapped-out pages of the AMEM 123 (see FIG. 1) are managed as an LRW list. FIG. 9 illustrates the LRW list 830 arranged in an order of recently written pages. Where a page 901 is swapped out and a read-only permission is set thereon, where a process accesses the page 901 corresponding to a write operation at t0, a write page fault occurs.

The page in which the write page fault occurs is moved to a head of the LRW list at t7 as illustrated in FIG. 9, and the swap controller 117 (see FIG. 1) changes the read-only permission into read/write permission corresponding the page where the write page fault occurs.

No more page faults occur until the migration daemon 820 (see FIG. 8) scans the LRW list and then the read/write permission is newly set corresponding to the page where the write page fault has occurred even where write operations have intensively takes place. In order to prevent recently swapped-in pages from being swapped out again since the free page of the DRAM 121 is exhausted, the migration daemon 820 scans the LRW list only where the free memory of the DRAM 121 exceeds a predetermined value.

The migration daemon 820 marks pages to be migrated, wherein the pages have been accessed at least once by a process corresponding to a write operation and read/write permission is set corresponding to the pages. In addition, the migration daemon 820 re-sets a read/write permission bit to read-only in a page table entry of the corresponding pages. Through the above operations, pages on which a write operation has been recently performed are gathered in the head of the LRW list. The pages marked and set to read-only may be moved to the DRAM 121 by the migration daemon 820.

Alternatively, although the pages marked and set to read-only are selected to be migrated, the actual migration of these pages to the DRAM 121 may be executed only where the write is performed on the pages. In this case, a page fault occurs since the pages are read-only, and the page fault handler 119 (see FIG. 1) may move the pages where the page fault occurs to the DRAM 121.

Meanwhile, even where a write is performed on the pages set to read-only, the migration daemon 820 does not migrate the pages where the number of free pages of the DRAM 121 does not exceed a predetermined threshold value, but moves the pages on which the a write operation is performed to the head of the LRW list and re-sets the read/write permission bit from read-only permission to read/write permission.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

As described above, an asymmetric memory (AMEM) utilized as swap storage allows much faster swap-out and swap-in, as compared with a hard disk drive or a NAND memory used as swap storage. In addition, the AMEM may be read on a byte basis like a DRAM, and thus it is possible to improve a read performance of the memory by reading data directly from the AMEM without recovering the data to the DRAM which is generally performed in the swapping-in operation. Moreover, unlike the DRAM, the AMEM does not require power to refresh, and accordingly, it is possible to reduce power consumption when the AMEM is used as swap storage, compared to where more DRAMs are installed.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A memory system, comprising:
an asymmetric memory;
a dynamic random access memory (DRAM); and
a control unit configured to use the asymmetric memory as swap storage of the DRAM and to move a page selected to be swapped out by the DRAM to the asymmetric memory.

2. The memory system of claim 1, wherein the control unit is further configured to map an address of a page which is directly swapped out to the asymmetric memory to a page table of the swapped-out page such that a process is capable of directly accessing the swapped-out page.

3. The memory system of claim 1, wherein the control unit is further configured to assign a lower priority to pages on which write operations are frequently performed in response to selecting the pages to be swapped out.

4. The memory system of claim 3, wherein the control unit is further configured to manage pages with an active list and an inactive list, the active list comprising pages which have been recently referred to, the inactive list comprising pages which have not been recently referred to and being divided into an inactive write list and an inactive read list according to an occurrence of write operations.

5. The memory system of claim 4, wherein the control unit is further configured to:
scan the inactive write list and the inactive read list; and
promote pages which have been recently referred to twice or more to the active list.

6. The memory system of claim 4, wherein the control unit is further configured to:
reduce the active list by moving pages which have not been recently referred to from the active list to either the inactive write list or the inactive read list according to an occurrence of write operations in each page;
reduce the inactive write list by moving pages to which a write operation has not been recently performed to the inactive read list; and
select pages to be swapped out from the inactive read list after reducing the inactive write list.

7. The memory system of claim 6, wherein, in response to reducing the inactive write list, the control unit is further configured to scan a page and locates the scanned page in a tail of the inactive read list in response to it being determined that a dirty bit and a reference bit have not been set corresponding to the scanned page with reference to a page table entry of the scanned page.

8. The memory system of claim 1, wherein the control unit is further configured to:
manage the swapped-out pages with a least recently written (LRW) list arranged in the order of recently written pages; and
select most recently written pages to be swapped in.

9. The memory system of claim 8, wherein the control unit is further configured to:
assign a read-only permission corresponding to the swapped-out pages;
change a read-only permission corresponding to the swapped-out page to a read/write permission in order to permit a write operation on the page in response to a write request corresponding to the swapped-out page being received; and
move the page to which the write operation has been performed to a head of the LRW list.

10. The memory system of claim 8, wherein the control unit, in response to scanning the LRW list, is further configured to:
mark pages to be migrated, the pages having a read/write permission assigned;
change a status of the marked pages to read-only;
generate a page fault in the marked page where write access to the marked page occurs; and
move the page where the page fault has occurred to the DRAM.

11. The memory system of claim 1, wherein the control unit is further configured to move the swapped-out pages to the DRAM in response to a size of a free page in the DRAM exceeding a threshold value.

12. A method of managing a memory system comprising an asymmetric memory and a dynamic random access memory (DRAM), the method comprising:
moving pages selected to be swapped out by the DRAM to the asymmetric memory by using the asymmetric memory as a swap storage of the DRAM.

13. The method of claim 12, further comprising mapping an address of a page which is directly swapped out to the asymmetric memory to a page table of the swapped-out page such that a process can directly access the swapped-out page.

14. The method of claim 12, further comprising assigning a lower priority to frequently written pages in response to the pages being selected to be swapped out.

15. The method of claim 12, further comprising:
in order to select the pages to be swapped out, managing pages with an active list and an inactive list, the active list comprising pages which have been recently referred to and the inactive list comprising pages which have not been recently referred to,
wherein the inactive list is divided into an inactive write list and an inactive read list according to an occurrence of write operations.

16. The method of claim 15, further comprising scanning the inactive write list and the inactive read list and promoting pages which have been recently referred to twice or more to the active list.

17. The method of claim 15, wherein the managing of the pages comprises:
reducing the active list by moving pages which have not been recently referred to from the active list to either the inactive write list or the inactive read list according to an occurrence of write operations to each page;
reducing the inactive write list by moving pages to which a write operation has not been recently performed to the inactive read list; and
selecting pages to be swapped out from the inactive read list.

18. The method of claim 12, further comprising:
managing the swapped-out pages with a least recently written (LRW) list arranged in the order of recently written pages; and
selecting most recently written pages been performed to be swapped in.

19. The method of claim 18, wherein the managing of the swapped-out pages comprises:
assigning read-only permission corresponding to the swapped-out pages;
changing the read-only permission corresponding to the swapped-out page to a read/write permission in order to permit a write operation to be performed on the page in response to a write request corresponding to the swapped-out page being received; and
moving the page to which the write operation has been performed to a head of the LRW list.

20. The method of claim 18, further comprising:
in response to scanning the LRW list:
marking the pages to be migrated, the pages for which a read/write permission is assigned; and
changing the status of the pages to read-only;
generating a page fault in the marked page in response to a write access occurring to the marked page; and
moving the page where the page fault has occurred to the DRAM.
